(19) United States
(12) Patent Application Publication
(10) Pub. No.: US 2007/0250899 A1
(43) Pub. Date: Oct. 25, 2007

(54) Nondestructive self-publishing video editing system

(75) Inventors: Scott Rhodes, Larchmont, NY (US); Steven Glen Durham, New York, NY (US); Arkady E. Dudko, Tenafly, NJ (US); Jason Jeffries, Brooklyn, NY (US)

Correspondence Address: KEITH D. NOWAK, CARTER LEDYARD & MILBURN LLP, 2 WALL STREET, NEW YORK, NY, 10005, US

(73) Assignee: Veotag, Inc., New York, NY (US)

(21) Appl. No.: 11/497,010

(22) Filed: Aug. 1, 2006

Related U.S. Application Data
(60) Provisional application No. 60/791,292, filed on Apr. 11, 2006.

(51) Int. Cl. H04N 7/16

(52) U.S. Cl. 725/136

(57) ABSTRACT

A video publishing and viewing system that allows the user to select a video on the user's network or on the Internet and produce a hierarchical menu describing the video content. The editing user can perform the entire process of selecting the video, creating the hierarchical menu along with descriptive text, and uploading the file from the same system, which is run entirely in a Web browser. The produced index is independent of the file formats as well as different play rates (low and high bandwidth). The same index appears for all viewings (or listenings) of the file. The system includes an auto-export feature that allows external search engines to look inside the video menu and make the video itself clickable and searchable as if it were a book (through the menu). The system also allows the user to build on already annotated videos by creating a new program from program fragments (hierarchical menu items) such that destructive video editing is not required.

### BACKGROUND OF THE INVENTION

This invention relates to video, specifically to improving the interaction with the video by adding a hierarchical menu to a video so that the user can quickly navigate the video to watch only parts he or she wants to see. Today video viewing, especially for long-format videos, is an unpleasant experience because the user is required to watch the entire video to find out its content. This prevents the viewer from using the video as a reference material in the same way as a textbook that has an index.

Companies typically solve this problem by using one of several means:

1. A one-off or consulting project is done to tie specific parts of the video to clickable links that point to specific parts of the video.

2. A system is developed which annotates the video with text and/or descriptive information. That descriptive information is then tied to the video by creating a new file that is used by a special-purpose player. An example of this is the Annodex technology. This results in losing the benefits of the original player environment. Here, the Annodex system loses the ability to be used with commercially available streaming technologies (including the random access technology) and is tied to a specific player.

Both of these solutions result in a nonrepeatable product that requires highly technical talent to produce and is costly to implement.

Importantly, most solutions along this line are destructive in that they will change the content of the video. In no case will the technology be used to produce a single annotation that can span multiple player formats (for example, Windows Media Video and Flash Video) with no additional work.

Additionally, the ability to tie together individual sections of different videos from different sources is typically a very time-consuming task. Normally, a person would need to create a new physical file with the contents of the desired individual segments. This is akin to the old editing room splicing of film. Once the film is cut, the original is lost unless a copy is made. In terms of storage, this means that to create a single video of 1 hour with 10 variations on an embedded 15-second segment, one would need storage for 10 hours of video. If, on the other hand, the process is nondestructive, then one only needs storage for one hour plus some small text descriptor.

U.S. patent application Ser. No. 10/710,614 to Meyers et al. discloses an indexable multimedia menu. However, the indexable multimedia menu is created by the publisher, not the user; does not reference indexing in the time domain; and does not state that the indexing is performed without alteration of the underlying media or is exportable to searchable media databases.

U.S. patent application Ser. No. 10/235,886 to Lin et al discloses a 2-level video menu where the first level consists of different video files and the second level consists of different chapters within each video file. Selecting the desired chapter designation allows play back of the portion of the video file indexed to that chapter by a playback command linked to the chapter designation. Lin et al alters the underlying media. Lin et al is not usable with a multitude of media player formats, but instead appears to be a proprietary system. Similarly, this would preclude the menus created using Lin et al from being exportable to searchable media databases.

U.S. Pat. No. 6,654,040 to Hui is limited to an XML-based time marker for synchronizing multimedia using SMIL (Synchronized Multimedia Integration Language) such that a user can enter a multimedia presentation from one of many points. Additionally, the time markers associated with the multimedia presentation are coded by the publisher, not the user, using XML/SMIL. Use with a multitude of media player types as well as menus being exportable to searchable media databases are doubtful.

U.S. patent application Ser. No. 10/122,797 to Van De Streek et al. discloses selecting a location in a video by the use of a slider that shows the relative position within the video, a plurality of scene indicia above the slider, and a pre-selected scene image associated with at least some of the scene indicia As the slider cursor becomes proximate to one of the scene indicia, the related pre-selected scene image is high-lighted and accessible. The differences from the present invention are apparent.

U.S. patent application Ser. No. 10/792,175 to Finke-Anlauff et al. discloses a media based diary in which media is imported into an electronic diary device at a certain time location within the diary based on time stamp metadata within the media being matched to the appropriate day and date screen within the electronic diary. The differences from the present invention are apparent.

U.S. patent application Ser. No. 10/066,144 to Wallace et al discloses a system for selecting among a plurality of different contrasting scene portions of a DVD or the like (i.e. an extended battle versus a short battle scene or a happy ending versus a sad ending) as well as a display cue of the scenes selected. The differences from the present invention are apparent.

U.S. Pat. No. 6,747,674 to Asami discloses the automated selection of a plurality of video scenes based on a desired starting point in time, desired time intervals between scenes and desired number of total scenes. The resulting scenes are displayed in thumbnail format in time sequence to be viewable and selectable by a user. The differences from the present invention are apparent.

In conclusion, no system has been developed that allows the user to:

1. Create an hierarchical menu to navigate the video without physically changing the video or tying it to a particular player technology

2. Create a new video from pieces of an old video without editing the original

3. Publish the menu and video combination to outside users without any technical help or outside equipment.

### SUMMARY OF THE INVENTION

The invention, an improved video editing and publishing system, allows any nontechnical user to self-publish a video index with a hierarchical menu. The user simply selects a video and while watching it in a player window, stops the video, types some descriptive text, and then lets the player continue. The menu can then be manipulated by indenting or “outdenting” the elements to create a clickable table of contents. While playing, the menu “animates” by expanding and collapsing the current segment and highlighting the segment currently playing.

The second part of the invention builds on the first by using the annotations or tags as the input to a process that allows the user to choose particular elements for a video jukebox that plays any menu elements of any video in any order. Hence, one could annotate ten football games and then make a new video of only the end runs in the games by simply selecting the end runs from the annotated videos. The underlying videos would not be affected. The player simply retrieves the selected segments from the diverse files and plays the pieces desired.

Accordingly, several objects and advantages of the invention are to provide a simple annotating experience that integrates all the parts of the production problem: tagging, uploading and providing online storage for public consumption, and publishing the created indexes (menus and supporting data) to the Internet search engines for easy discovery. This is unique in that it provides the entire mechanism for this process to the lay user. Second, using this process to provide an editing experience that allows the user to create different viewing experiences based on user need by cobbling together disparate videos without changing them and getting the same menu experiences is a huge step forward in Internet-based video editing. Third, the indexes that are created are independent of the files (but tied to the time-line) and are used for all the different versions of the file to be delivered. Hence, the same index can be used for Flash video and Windows Media Video for all of the different bandwidths to be delivered. This extends even to an audio-only presentation that might be delivered to a low-bandwidth client.

### BRIEF DESCRIPTION OF THE DRAWINGS

These and other subjects, features and advantages of the present invention will become more apparent in light of the following detailed description of a best mode embodiment thereof, as illustrated in the accompanying Drawings.

FIG. 1 is a computer screen shot of a first graphical user interface screen of the subject invention;

FIG. 2 is a computer screen shot of a second graphical interface screen of the subject invention;

FIG. 3 is a computer screen shot of a third graphical interface screen of the subject invention;

FIG. 4 is a computer screen shot of a fourth graphical interface screen of the subject invention;

FIG. 5 is a computer screen shot of a fifth graphical interface screen of the subject invention;

FIG. 6 is a computer screen shot of a sixth graphical interface screen of the subject invention;

FIG. 7 is a computer screen shot of a seventh graphical interface screen of the subject invention;

FIG. 8 is a computer screen shot of a eighth graphical interface screen of the subject invention;

FIG. 9 is a computer screen shot of a ninth graphical interface screen of the subject invention;

FIG. 10 is a computer screen shot of a tenth graphical interface screen of the subject invention;

FIG. 11 is a software logic flow chart of the media authoring logic of the subject invention;

FIG. 12 a software logic flow chart of the media authoring logic of the subject invention; and

FIG. 13 a software logic flow chart of the media authoring logic of the subject invention.

### DETAILED DESCRIPTION OF THE PREFERRED EMBODIMENTS

The subject invention, in one embodiment, can be software for the editing, transfer and play-back of media. In this regard, the software of the subject invention can run on, by non-limiting example, an IBM-based or Apple personal computer preferably having at least one of an Internet or intranet network connection. When an IBM-based personal computer is employed, any well known operating system can be used such as LINUX or Microsoft XP or NT. Such an IBM-based personal computer can have, for example, a 1.0 GHz or more Intel central processing unit, 512 MB of random access memory (or more) and a 10 GB or larger hard drive. Media player software that interfaces with the subject invention includes, but is not limited to, Windows Media Player by Microsoft and Quicktime by Apple.

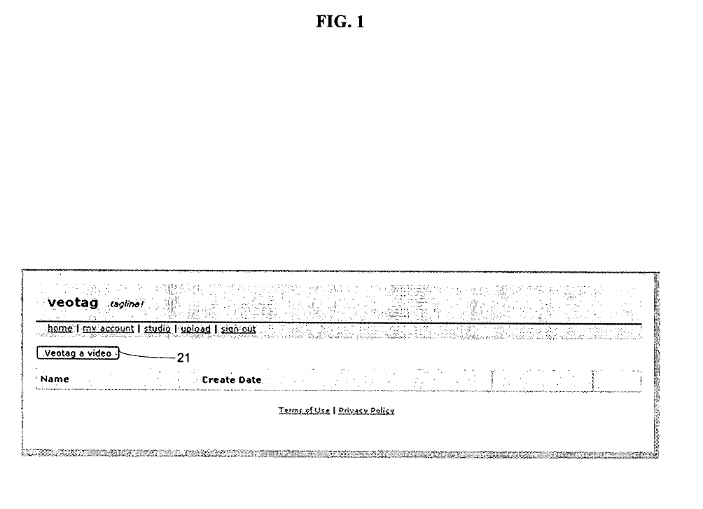

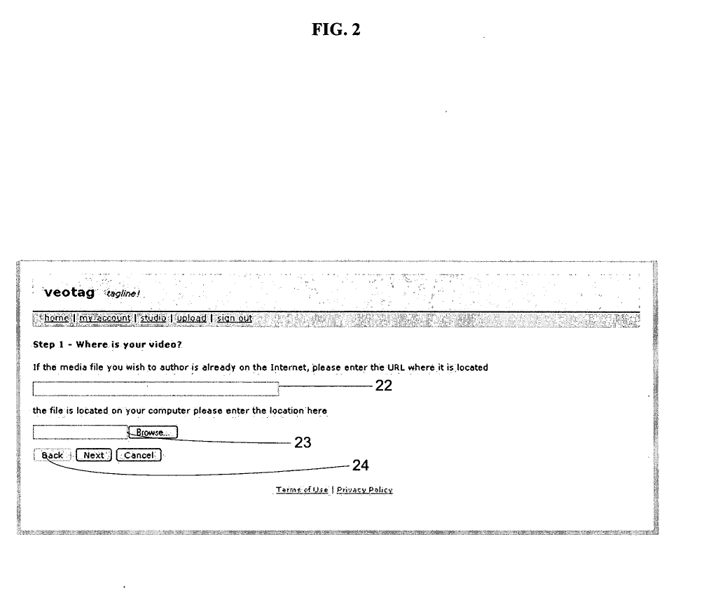

FIG. 1 shows the starting point in the graphical user interface of the subject invention for a user to create a video menu and its attendant artifacts. The user presses button 21 to begin. FIG. 2 shows the first step of a graphical user interface Wizard that guides the user the creation process. The user can select either from a URL 22 or the file system 23. After selecting the file, the user continues with the standard Wizard metaphor 24 to continue.

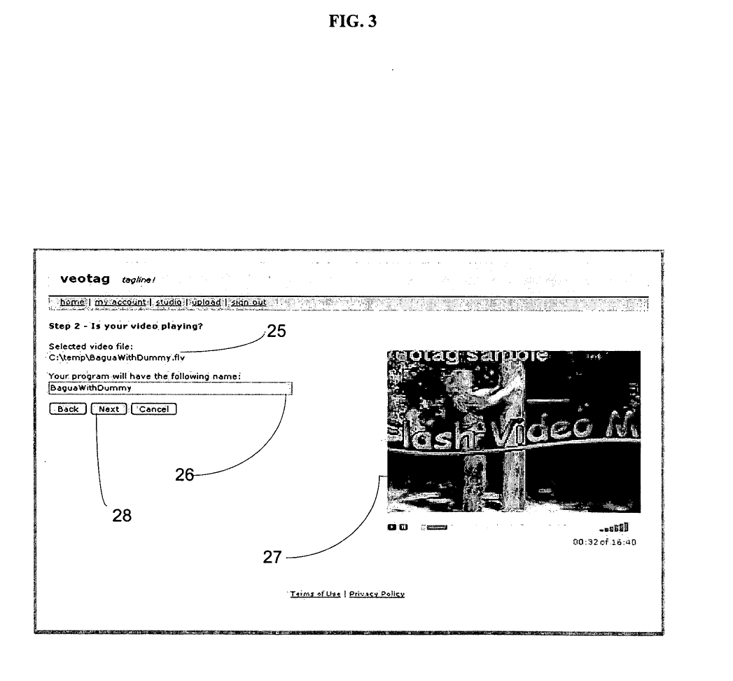

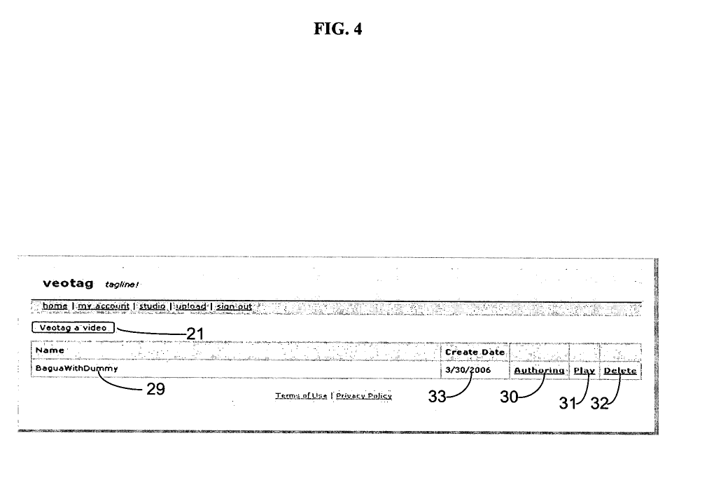

In FIG. 3, the invention validates that the user has found the video and has the correct playback technology to view it. The name (URI) 25 is displayed along with a program name 26. The video is playing in 27 to confirm that the right video is selected. When the user is content with what is shown, the user continues with button 28. In FIG. 4, the invention returns to the control screen with the new video name 29, edit link 30, player link 31, delete video program link 32, and the date (and possibly time) of creation. The user can create another new program by clicking button 21 again.

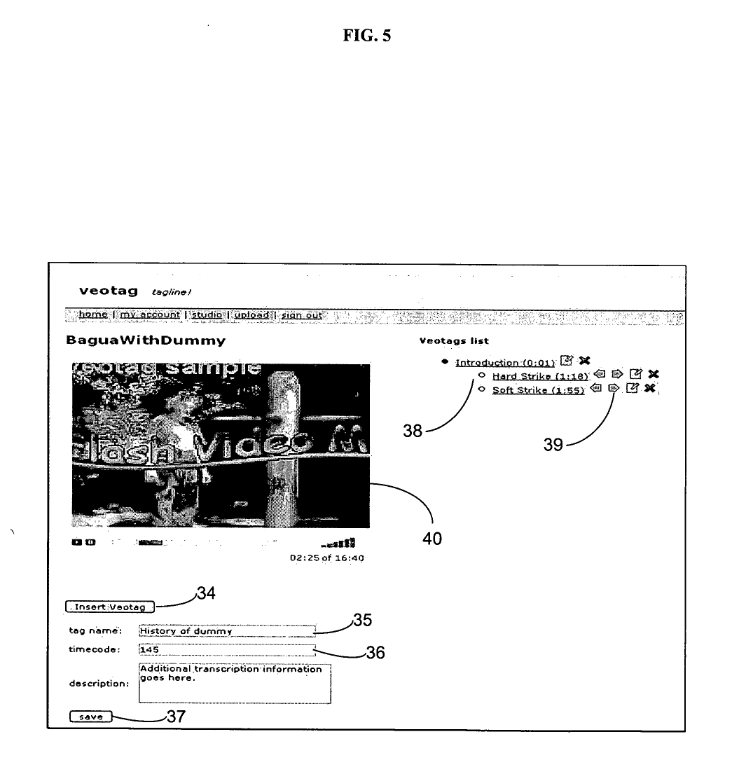

FIG. 5 shows the edit screen. To add a new menu item and attributes, the user clicks button 34. The user enters the name of the menu item 35, and the time code is shown along with any description or narrative in 36. The menu item is added to the list by clicking button 37. The current state of the menu is indicated in hierarchical menu 38, along with controls for the menu items in 39.

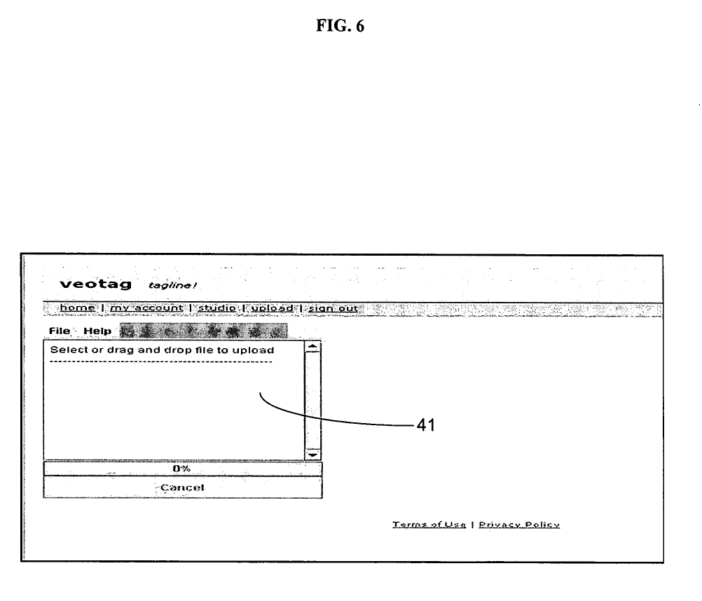

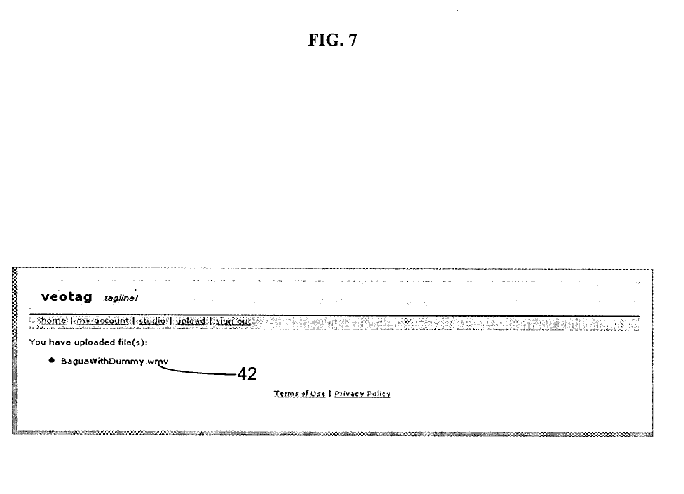

FIG. 6 shows the file upload screen. Once the user has completed creating the program, the user can upload it (or tags associated therewith) to a public server if it has not already been done. The user may select to have the system automatically update the location of the program (or tags associated therewith) to point to the new location. FIG. 7 shows the confirmation screen for the upload showing the name of the uploaded file in 42. The file name presented is the one the user added, not the file name on the server that is hidden from the user.

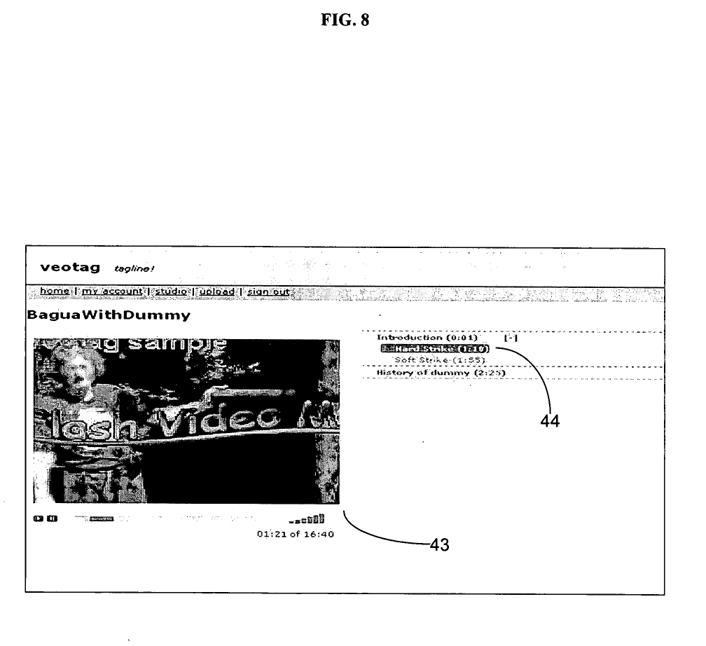

FIG. 8 shows a sample player window. The video window is shown in 43. The hierarchical menu appears in 44. As the video plays, the subsections open and collapse and the current item is highlighted.

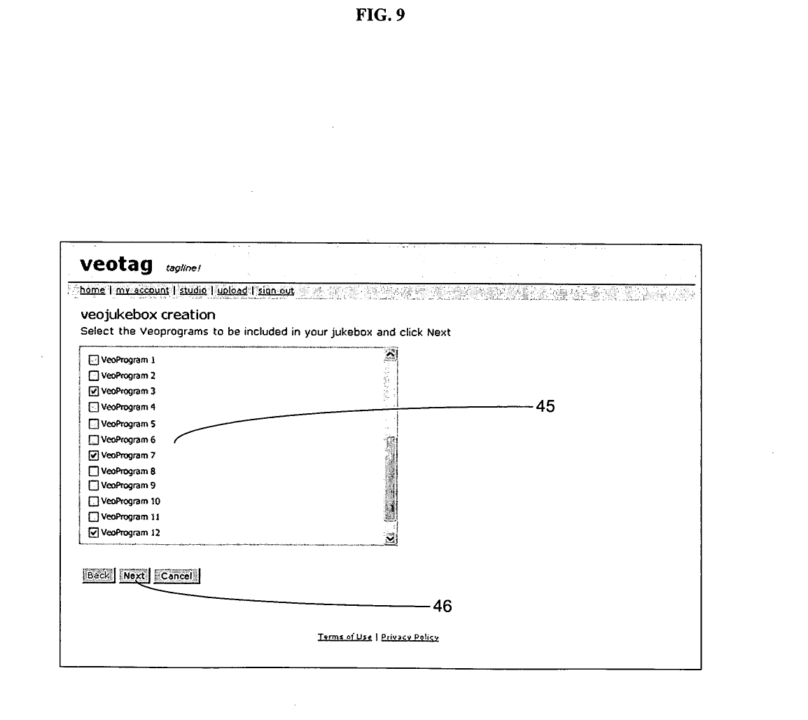

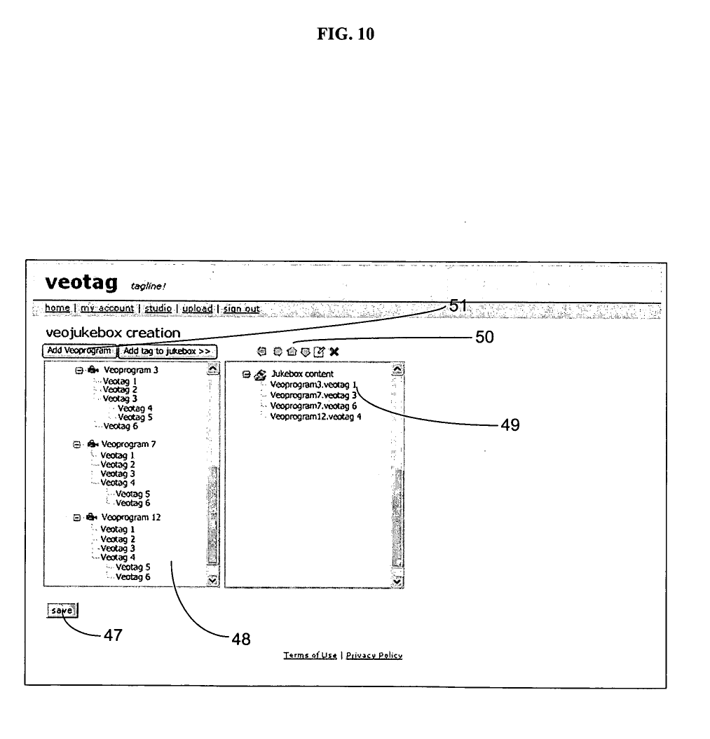

FIG. 9 shows the first graphical user interface screen to create a new video program from fragments of other already annotated programs. The program names appear in 45 and the Wizard buttons to control behavior appear in 46. This screen is used to select which source programs and program fragments will be used to create the video jukebox program. FIG. 10 is the second screen to create a new video jukebox program. Button 47 allows the user to save changes. The tree view 48 shows the selected programs and the program fragments. The selected items and their current order and indentation are shown in 49. Indent, outdent, edit, promote (earlier in time), demote (later in time), and delete item are shown in 50. To add a new item to the left tree view, the user selects button 51.

In operation one uses the media publishing system of the present invention using a simple text editing metaphor with the added functionality of a hierarchical menu for the text items. The benefit of the system is that the naïve user is presented with a complete system to select, annotate (create an hierarchical menu), upload, and then publish the new program to the outside world as a single integrated package.

The steps to create a program are as follows:

1. In FIG. 1, create a new video program.

2. In FIG. 2, select a source video file using text area 22 or 23.

3. In FIG. 3, confirm the video plays 27 and name the new program 26.

4. In FIG. 4, click the authoring link 30 to begin editing. (This step may be elided, depending on the settings, to allow editing to be performed immediately).

5. In FIG. 5, the main authoring window. The user views the video 40 until the user wants to add a new menu item. The user clicks the insert button 34 and is presented with the menu item to add 35, the time code 36, and the description (some people use this as a transcription area). The new item is committed on clicking save 37. The current menu appears in 38 with the menu position controlled in 39. The item may be further edited or deleted by using the buttons in 39.

6. In FIG. 6, if the user has the file on a local file system, the user may elect to upload it (or tags associated therewith) to the veotag server (or another non-veotag server, at the user's discretion). This can, at user election, automatically update the program to point to the new location. The menu, and links thereto, are published to the outside search engines automatically. This is one of the major benefits of the system because anyone searching for content on the topic can now open to the video that has been annotated and jump right to the part they want. Previously one could not seamlessly publish to other search engines without the search engines changing their underlying technology. Additionally, this is an advantage over an ad hoc system where the user would then need to do special work to publish the menus.

7. In FIG. 7, the user is presented with confirmation of the upload process and the uploaded source file 42.

8. In FIG. 8, the user is viewing the finished product. Hereto we have described the editing user, this is the screen the end-user sees. The video is playing in 43 and the menu is animating (opening, collapsing, highlighting) in 44. This is where the benefit is derived from the editing process.

9. In FIG. 9, the editing user selects from amongst already created video programs those needed for a combined playback. The list is given in 45.

10. In FIG. 10, the editing user selects the program fragments for playback and controls them in the same way, once selected, as the simple program. There is no destructive editing of the video segments and a new video can be produced from a collection of old ones in a few minutes of work without any specialized hardware. Playback occurs using the same player and gives the same experience as in FIG. 8 except that now multiple videos (and/or pieces of them) have been strung together for a nearly seamless viewing experience for the viewer.

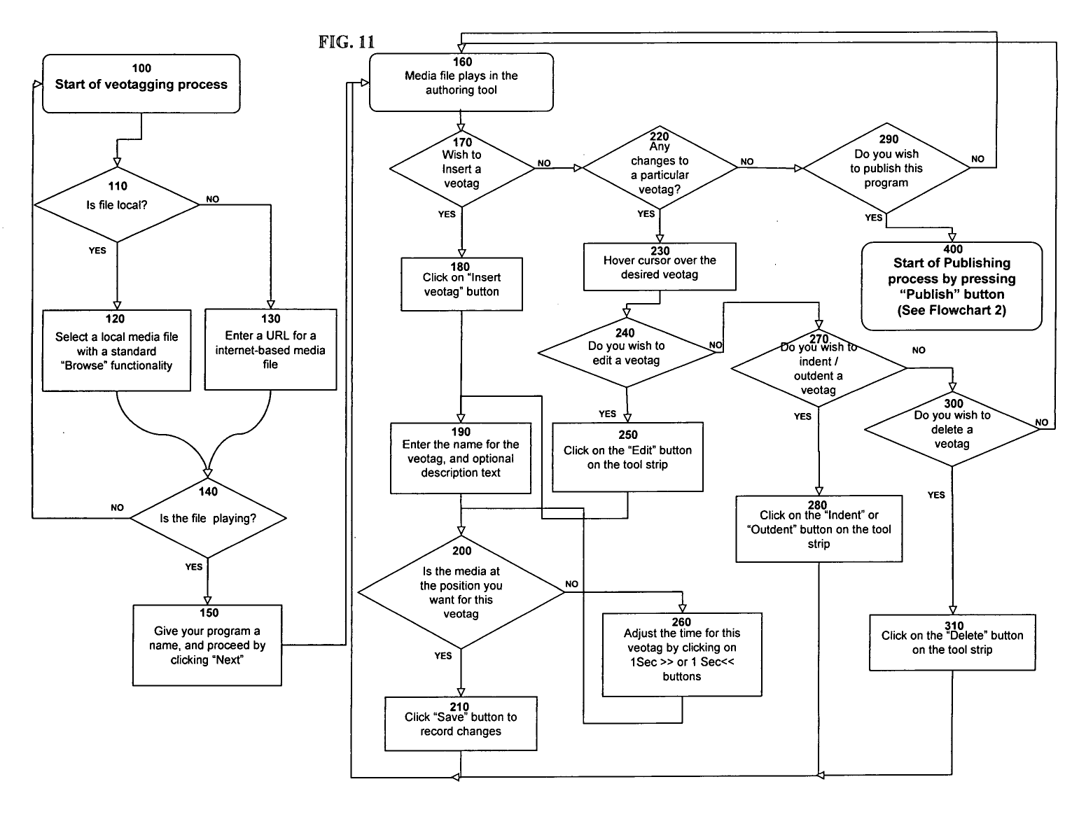

Next referring to FIGS. 11, 12 and 13 the logic of the software of the subject invention is described with reference to logic flow charts. These logic flow charts can be coded to create the software of the subject invention in many different software languages, including but not limited to C, C++, and Java.

FIG. 11 shows the media authoring logic. At block 100 the process begins when a user has signed in with their user id and password and has clicked on a <<CREATE NEW>> button. At block 110 a user needs to select a media file to veotag. The media file can be resident on their computer, or on their local are network (LAN), or the file can be on some web server that can be accessed via an internet address (URL). At block 120 this step is selected if the file is on a local computer, or on a LAN. Standard “Browse” dialogue allows users to navigate to that file by selecting drives and a folder that the file is on. At block 130 this step is performed if the file is being played from some internet server. The user must know the URL to that file. At block 140 once the location of the file is specified, a player window is displayed, and the application attempts to play the file. This will test if the address was entered correctly, or if the application supports this type of a file. At block 150 if the file is playing successfully, it can be veotagged. At this step a user will enter a name for their program (combination of a media file and the accompanying veotags and descriptions). At block 160 the media file plays in the main veotagging player. This player will have controls to pause/play the file, a slider bar to move around in the file, and a button to insert a veotag. At block 170 this decision is made when the media file has reached a point that a user wishes to be marked by a veotag. At block 180 by clicking on the “Insert Veotag” button, the play pauses at that moment, and a user is presented with text areas to enter the name and a description for this veotag. At block 190 name and description are entered by typing them in into text areas that become visible at this step. A user can cancel their action by clicking on a “Cancel” button. At block 200 this decision is made to fine tune the exact time location for any veotag. During insertion or editing of any veotag, a decision can be made to adjust the exact temporal coordinate for this veotag. If a change to the temporal position of this veotag is desired, user proceeds to step 260. At block 210 once the desired name, description, and a temporal location for a particular veotag is established, this information is saved in the database by clicking the “Save” button. At block 220 a decision to edit any already existing veotag can be made during any time inside the authoring process. At block 230 if a user decides to make any changes to any of the veotags, hovering their mouse cursor over any particular veotag will display a “tool strip” with several icons that can perform number of action. Possible action decision are described in steps 240, 270, 300. At block 240 this decision is made if any particular veotag needs to have their name, description or the prices time coordinate to be changed. If changes are desired, user proceeds to step 250. At block 250 clicking on the “Edit” icon on the tool strip puts the user into “edit mode”, and the workflow moves to step 190. At block 260 exact temporal coordinate can be adjusted by clicking “1 Second Forward” or “1Second Backward” buttons. After each temporal adjustment, the workflow is at step 200. At block 270 a decision can be made to change the indentation level for each veotag. This determines the hierarchical structure for the whole program. If change in the indentation level is desired, proceed to step 280. At block 280 the tool strip for a selected veotag will have 2 buttons that control the indent level. Clicking on the “indent” or “out dent” buttons on the tool strip will move that veotag, and all of its subordinate veotags one level deeper, or move them one level up in the hierarchy of the veotags. That ends that edit for that tag, and the process is back at step 160. At block 290 a decision to publish this program can be made at any time during the authoring process. Publishing a program makes it usable by others. Publishing process is described by the flowchart #2; step 400. At block 300 a decision to delete any veotag can be made throughout the authoring process. If a user wishes to delete any veotag, they proceed to step 310. Otherwise process continues at step 160. At block 310 the tool strip will have an icon on it designated for deletion of a veotag. Clicking on that icon deletes that veotag from the database and the process continues at step 160.

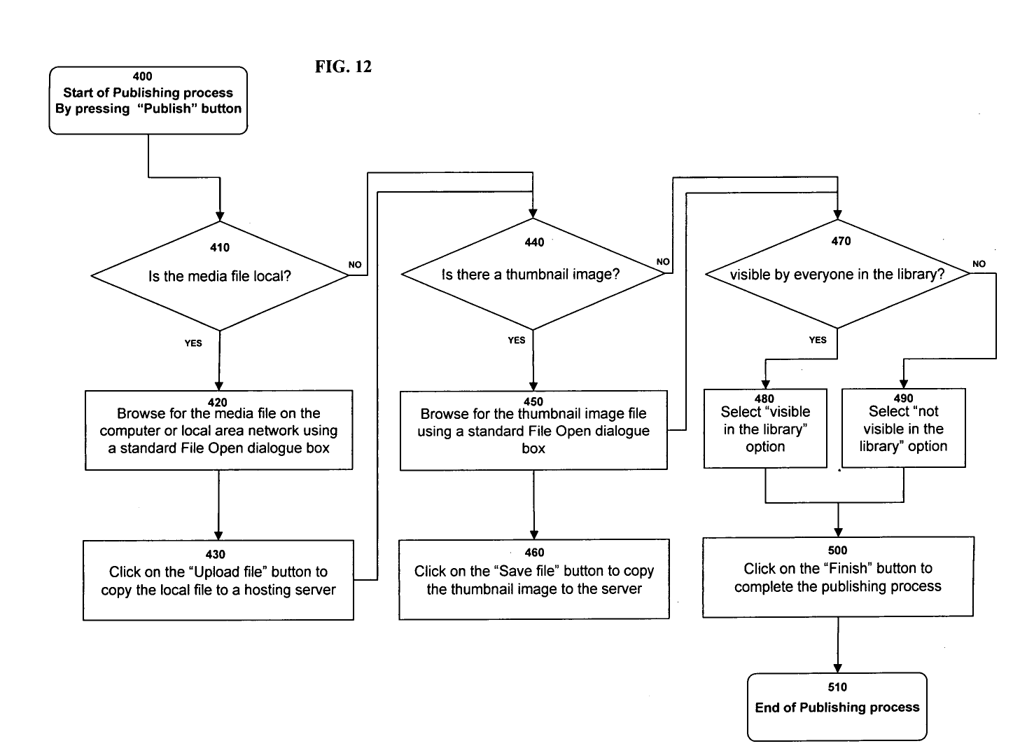

FIG. 12 shows the media publishing logic. At block 400 publishing of a veotag program starts when a user clicks on the “Publish” button on the authoring screen. This takes a user to the Publishing page. At block 410 first step in the publishing process is to upload your local media file (or tags associated therewith) to a web-based hosting server. The need for that is determined in this step. If the media file (or tags associated therewith) is local to a user's computer or local are network (LAN) user proceeds to step 420. If the file (or tags associated therewith) is already available on the internet user proceeds to step 440. At block 420 using a standard file browsing dialogue a users navigates to the media file (or tags associated therewith) that was selected for this veotag program in step 120. At block 430 after navigating to the desired media file (or tags associated therewith), the user clicks on the “Upload” button. That will copy the file (or tags associated therewith) to a hosted web server. A progress meter is displayed, and upon completion of the upload user proceeds to step 440. At block 440 for each program a user can select a thumbnail image that will get displayed in the library along side with that program. If there is a thumbnail image, proceed to step 450, otherwise proceed to step 470. At block 450 thumbnail image file is located using a standard “File Open” dialogue box. At block 460 once the file is located, “Save” button will upload this file (or tags associated therewith) to the veotag web serer, and assign it to that program. At block 470 a user can make a decision whether this program will be visible by everyone via the veotag library (Public), or only by select number of people (Private). If a user wishes to make this program public, proceed to step 480, otherwise proceed to step 490. At block 480 user will make the program viewable by everyone by selecting “Public” radio button. At block 490 user will make the program not visible in the library by selecting “Private” radio button. At block 500 clicking on Finish completes the Publishing process. At block 510 user is taken out of the Publishing screen to the list of their veotagged programs.

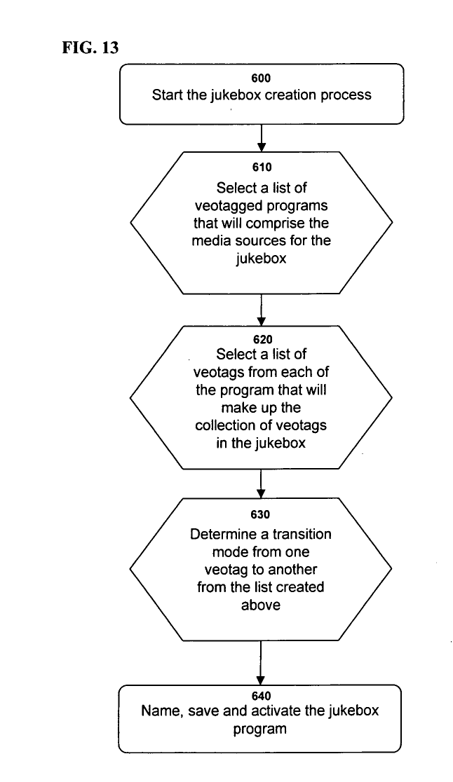

FIG. 13 shows the jukebox creation logic. At block 600 starting of the jukebox creation begins with a user choosing to “Create a jukebox program” from their main menu. At block 610 in this step a user identifies which programs will be included in this particular jukebox collection. After selecting the list of programs, user proceeds to step 620. At block 620 a user will select a number of veotags from the collection of veotagged programs selected in step 610. At block 630 for each veotag selected in step 620 a user will determine when the jump to the next veotag will occur. At block 640 the jukebox program is saved in this step, and is given a name, and access levels to this jukebox program is established.

Although the invention has been shown and described with respect to a best mode embodiment thereof, it should be understood by those skilled in the art that carious changes, omissions, and additions may be made to the form and detail of the disclosed embodiment without departing from the spirit and scope of the invention, as recited in the following claims.

We claim:

1. A media compilation method comprising:
selecting media from at least one of a local computer, an intranet networked computer or an Internet location;
displaying said media;
selecting portions of said displayed media;
identifying said selected portions using an identification tag,
saving said identification tag along with a time code of said selected portions in a user accessible database, said identification tag saving and said time code transcendent of media player type; and
indexing said identification tag along with said time code of said selected portions of said displayed media in a user determined hierarchy of entries, neither of said saving nor said indexing altering said media.

2. The method of claim 1 further comprising uploading with linking said indexed, selected portions of said displayed media to a searchable media database whereby said linking allows media compilation playback by link actuation.

3. The method of claim 1 wherein said indexing includes the addition of personal descriptors for each of said entry of said index.

4. The method of claim 1 wherein upon playback of said media compilation each of said entry of said index is visible and highlighted.

5. The method of claim 1 further comprising creating a jukebox of only selected ones of said entries of said index.

6. A media compilation method comprising:
selecting media from at least one of a local computer, an intranet networked computer or an Internet location;
displaying said media;
selecting portions of said displayed media;
identifying said selected portions using an identification tag;
saving said identification tag along with a time code of said selected portions in a user accessible database, said identification tag saving and said time code transcendent of media player type;
indexing said identification tag along with said time code of said selected portions of said displayed media in a user determined hierarchy of entries, neither of said saving nor said indexing altering said media; and
uploading with linking said indexed identification tag along with said time code of said selected portions of said displayed media to a searchable media database whereby said linking allows media compilation playback by link actuation.

7. The method of claim 6 wherein said indexing includes the addition of personal descriptors for each of said entry of said index.

8. The method of claim 6 wherein upon playback of said media compilation each of said entry of said index is visible and highlighted.

9. The method of claim 6 further comprising creating a jukebox of only selected ones of said entries of said index.

10. A media compilation system comprising:
a component for selecting media from at least one of a local computer, an intranet networked computer or an Internet location;
a component for displaying said media;
a component for selecting portions of said displayed media;
a component for identifying said selected portions using an identification tag;
a component for saving said identification tag along with a time code of said selected portions in a user accesable database, said identification tag saving and said time code transcendent of media player type; and
a component for indexing said identification tag along with said time code of said selected portions of said displayed media in a user determined hierarchy of entries, neither of said saving nor said indexing altering said media.

11. The system of claim 10 further comprising a component for uploading with linking said indexed, saved selected portions of said displayed media to a searchable media database whereby said linking allows media compilation playback by link actuation.

12. The system of claim 10 wherein said indexing includes the addition of personal descriptors for each of said entry of said index.

13. The system of claim 10 wherein upon playback of said media compilation each of said entry of said index is visible and highlighted.

14. The system of claim 10 further comprising creating a jukebox of only selected ones of said entries of said index.

15. A media compilation system comprising:
a component for selecting media from at least one of a local computer, an intranet networked computer or an Internet location;
a component for displaying said media;
a component for selecting portions of said displayed media;
a component for identifying said selected portions using an identification tag;
a component for saving said identification tag along with a time code of said selected portions in a user accesable database, said identification tag saving and said time code transcendent of media player type;
a component for indexing said identification tag along with said time code of said selected portions of said displayed media in a user determined hierarchy of entries, neither of said saving nor said indexing altering said media; and
a component for uploading with linking said indexed identification tag along with said time code of said selected portions of said displayed media to a searchable media database whereby said linking allows media compilation playback by link actuation.

16. The system of claim 15 wherein said indexing includes the addition of personal descriptors for each of said entry of said index.

17. The system of claim 15 wherein upon playback of said media compilation each of said entry of said index is visible and highlighted.

18. The system of claim 15 further comprising creating a jukebox of only selected ones of said entries of said index.
